(19) United States
(12) Patent Application Publication
(10) Pub. No.: US 2002/0009695 A1
(43) Pub. Date: Jan. 24, 2002

(54) Drawing kit for imparting the appearance of texture to paper

(76) Inventors: Raheela Rasheed, Madison, AL (US); Abdul Rasheed, Madison, AL (US)

Correspondence Address: George P. Kobler, 2904 Gallalee Rd., Huntsville, AL, 35801, US

(21) Appl. No.: 09/924,881

(22) Filed: Aug. 8, 2001

Related U.S. Application Data
(63) Continuation-in-part of application No. 09/534,029, filed on Mar. 24, 2000.

(51) Int. Cl. G09B 11/00

(52) U.S. Cl. 434/85

(57) ABSTRACT

A drawing kit comprised of a plurality of plates, each having a texture disposed on at least one surface. The plates can be removably or permanently bound together in a binder, and said binder may have a recess on at least one cover adapted to receive a selected texture plate. The kit is used by overlaying a piece of paper on top of said texture plate and rubbing with a suitable marking implement. The paper may be of any size.

### CROSS-REFERENCE TO RELATED APPLICATIONS

This is a continuation-in-part of application Ser. No. 09/534,029 filed Mar. 24, 2000 and titled “Method and Device for Generating Various Types of Patterns and Surface Texture Within Drawn Objects and Artwork Using Special Templates and Color Pencils/Crayons” which is incorporated herein by reference.

### BRIEF DESCRIPTION OF THE DRAWINGS

FIG. 1A depicts the plan view of a texture plate according to the invention.

FIG. 1B shows the method of using a texture plate according to the invention.

FIG. 2 shows a texture plate with multiple textures disposed thereon according to the invention

FIG. 3 depicts a texture plates removably bound in a binder

FIG. 4 illustrates a cover of the binder according to the invention.

### DETAILED DESCRIPTION OF THE INVENTION

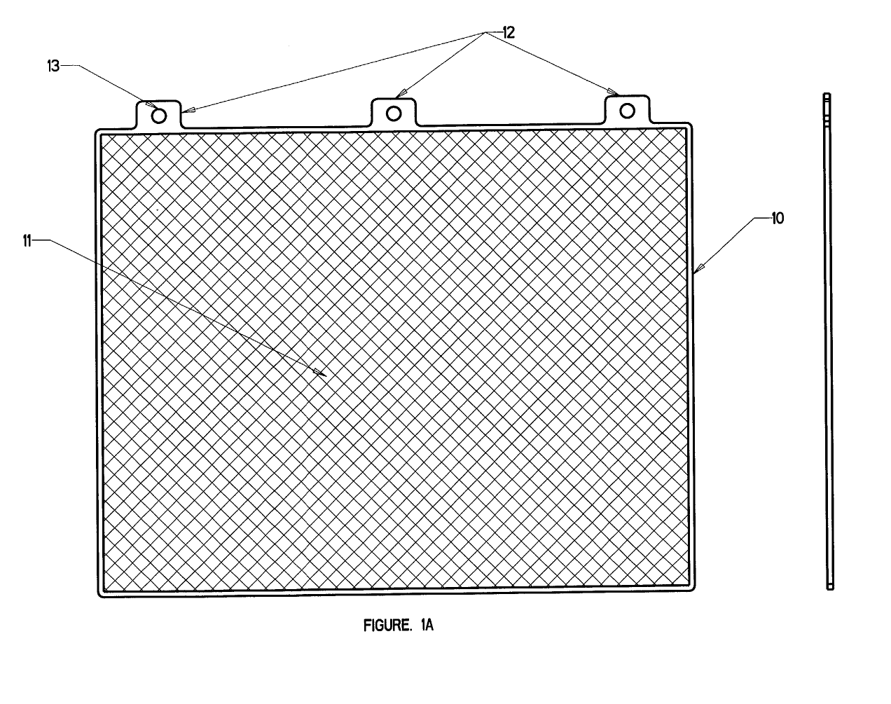

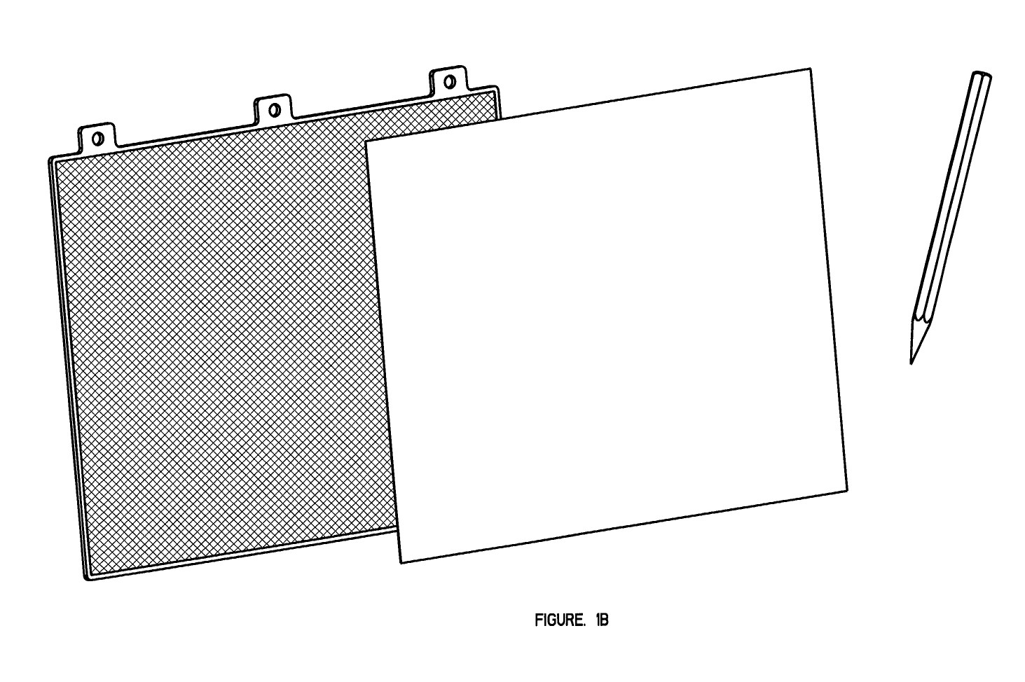

FIG. 1A depicts an exemplary texture plate 10 contemplated for use in the basic embodiment. The texture plate 10 has a textured surface 11 on at least one side, and the texture may be embossed upon the surface or engraved into the surface. Further, a different texture may be disposed upon the opposing surface. The texture plate 10 may have a rimmed margin, or shown, one or more margin tabs 12 appended to one edge into which one or more apertures 13 may be located. As discussed below, the apertures are for binding two or more texture plates together to form a kit. FIG. 1B depicts use of a texture plate 10. A piece of paper is overlaid thereon, and a rubbing is created using a suitable marking means such as a pencil, crayon, or charcoal. The textures may include replications of animal skin textures such as that of an alligator, an elephant or a fish. The textures may also include patterns formed from plant material such as tree bark, leaf skin texture or floral patterns. The textures may also include appearances of brick or stone walls or of geometric forms.

Additionally, a texture has been developed by the inventor by affixing a plurality of polygonal wafers to a rigid surface such that when a rubbing is created, the appearance of animal skin markings is perceived. The appearance is that of giraffe markings, but it can easily be seen that markings of many animals may be approximated in this manner. For example, animal skin markings could include skins of tiger, zebra, and leopard or cheetah.

The texture plates 10 do not have to be of any specified size or shape. An advantage of this plate element over other structures designed to aid in imparting textures to paper is that those prior designs may only receive certain sizes of paper. If the drawing desired to the textured is of a size greater than the area specified for overlaying the paper upon the texturing surface, a texture may be imparted, but at great risk of creasing or even damaging the paper. The benefit of the use of this plate is that any size paper may be used. If the paper used is much larger than the plate, the paper may yet receive the appearance of texture by merely rubbing one area and then shifting the plate or the paper to begin applying the texture to a fresh area of the paper. A further benefit of this kit form is the number of texture plates in the kit permit a diverse variety of textures to be applied to the paper.

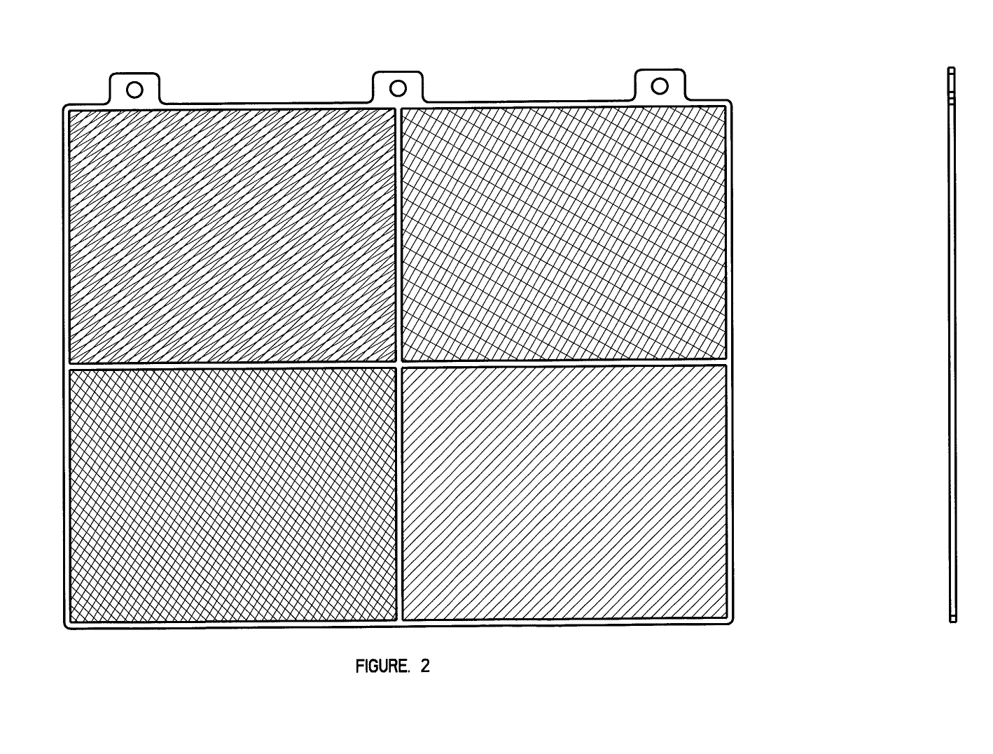

FIG. 2 illustrates a further embodiment of the present invention wherein multiple textures may be disposed upon the same surface of the texture plate. For the purposes of this invention, this version works well where storage space is a concern and the size of the overall kit is an issue.

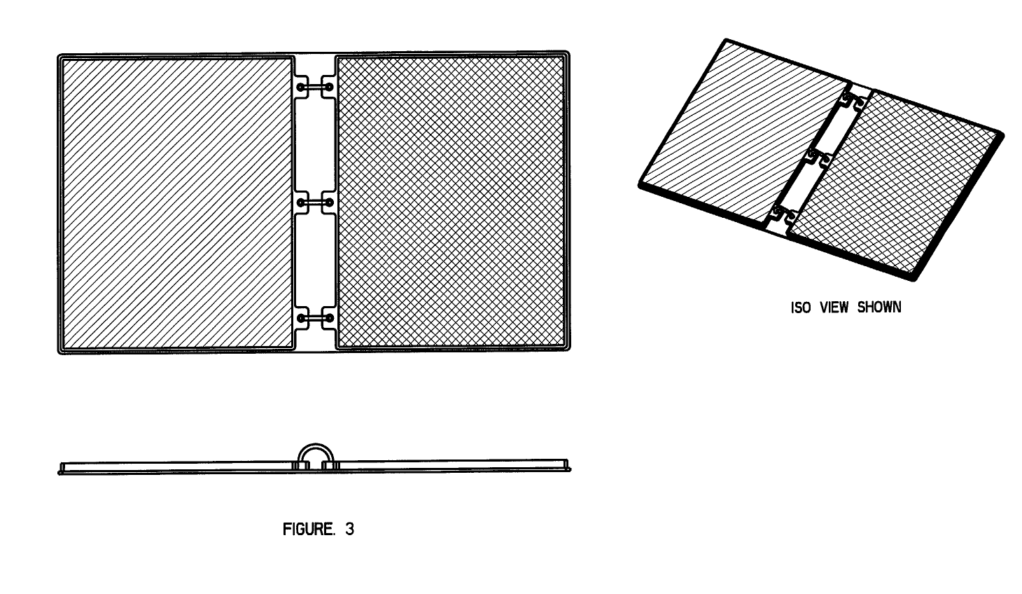

One embodiment of the kit is shown in FIG. 3. A plurality of textured plates 10 are kept together in a binder temporarily attached therein by binder rings inserted through the apertures 13 in the margin tabs 12 of the texture plates. Although FIG. 3 displays a three-ring/aperture configuration to bind the plates together, those skilled in the art will appreciate that the kit may be formed by at least one ring/aperture configuration and with a maximum number of apertures limited only by the dimensions of the plate and the desired aperture diameter. Additionally, the binding means employed need not comprise a cover, or covers.

Moreover, it should be noted that the templates may be permanently bound with spiral binding. When using this means to bind the texture plates, care should be taken to ensure that the spiral is of sufficient diameter such that a single texture plate may lie flat upon a drawing surface while the remaining texture plates in the kit are folded back to avoid interfering with use of the selected texture plate.

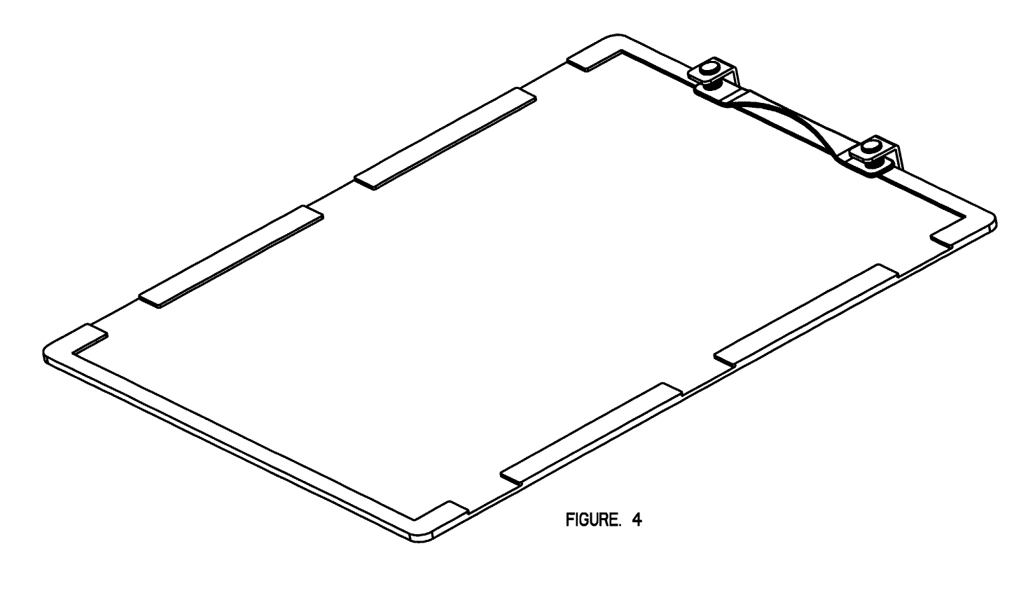

A version of the kit may include a means to secure a texture plate and a piece of paper. With reference to FIG. 4, the kit comprises at least one rigid cover 40, the outer surface of which envelopes a recessed area 41 within which a texture plate may fit snugly such that the surface of the texture plate is flush with the outer surface of the kit cover 40. The texture plate may be inserted within the recessed area 41 and a piece of paper overlaid thereon. The paper may be secured to the outer surface of the kit cover 40 with a clamp 42. The clamp may also be in the form of a frame, the length and width of which are substantially the same that as that of the kit cover. Additionally, if the kit cover is fabricated from magnetic material, the piece of paper may be secured to the outer surface by a magnet or a plurality of magnets. As an alternative, the kit could incorporate a binder design with two covers. In this case, the recess for housing the selected texture plate and the clamp for securing the paper while imparting the desired texture may be placed on the inside surface of either cover, or both covers.

Furthermore, the magnet or plurality of magnets may be housed within a frame, the outer dimensions of which are substantially the same as the outer dimensions of the kit surface. The frame describes an aperture such that when a piece of paper is placed upon the texture plate and the frame is placed thereon to secure the paper, the paper may be accessed by the user through the aperture and a rubbing may be created. The frame may be secured to the kit cover with a hinge to allow it to be opened or closed.

It should be noted that the texture plate may be held in place upon the outer surface of the kit cover by a number of means including clamps or magnets. Additionally, it is intended that the texture plates may be removed from the kit for use alone on any drawing surface.

In addition to the method for securing the texture plate to a binder cover described above, a binder cover may incorporate a clamping means to secure the texture plate to the surface of the binder cover. The texture plate clamping means could be affixed to either the inside surface or outside surface of the binder cover.

Alternatively, the texture plates may be contained in a receptacle adapted to receive them. Preferably, said receptacle should be adapted with means to hold the texture plates within the confines of the receptacle such as a lid, covering or other similar means for securing the contents within the receptacle. The receptacle could be a satchel, pouch or case. The receptacle is also preferably constructed with a rigid member comprising one surface. This rigid surface could be adapted as described above to receive a texture plate and provide a means for securing the paper overlaying said plate to the rigid surface.

As described above and shown in the associated drawings, the present invention comprises a drawing kit for imparting the appearance of surface texture to paper. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A drawing kit for imparting the appearance of surface texture to paper comprising:
a. A plurality of texture plates, each of said texture plates comprising a first surface, a texture being disposed upon said first surface, and at least one edge, and at least one aperture disposed within said at least one edge; and
b. A binding means adapted to bind said plurality of plates by said at least one aperture.

2. The drawing kit for imparting the appearance of surface texture to paper according to claim 1, wherein each of said plurality of texture plates further comprises a second surface, a texture being disposed upon said second surface.

3. The drawing kit for imparting the appearance of surface texture to paper according to claim 1, wherein said first surface of each of said plurality of texture plates comprises a plurality of different textures disposed thereon.

4. The drawing kit for imparting the appearance of surface texture to paper according to claim 3, wherein said second surface of each of said plurality of plates comprises a plurality of different textures disposed thereon.

5. The drawing kit for imparting the appearance of surface texture to paper according to claim 1 wherein said textures are embossed upon said first surface.

6. The drawing kit for imparting the appearance of surface texture to paper according to claim 1 wherein said textures are engraved upon said first surface.

7. The drawing kit for imparting the appearance of surface texture to paper according to claim 1, wherein said surface textures is one of the following texture types: animal skin textures; plant textures; or geometric shapes.

8. The drawing kit for imparting the appearance of surface texture to paper according to claim 1, wherein said binding means is adapted to permit removal at least one of said plurality of texture plates, and said binding means comprises a first binder cover having an outer surface with respect to contents of the binder, said outer surface being adapted to receive and hold at least one of said plurality of plates disposed thereon.

9. The drawing kit for imparting the appearance of surface texture to paper according to claim 8, further comprising a clamping means appended to said outer surface such that paper may be held in place on said outer surface.

10. The drawing kit for imparting the appearance of surface texture to paper according to claim 9, wherein said clamping means is a spring-clamp.

11. The drawing kit for imparting the appearance of surface texture to paper according to claim 9, wherein said clamping means is a magnet, and wherein said outer surface comprises material attractive to magnetic substances.

12. A drawing kit for imparting the appearance of surface texture to paper comprised of:
a. A plurality of plates, each of said plurality of plates having a first surface and a second surface, and an edge, said first surface having a rough texture disposed thereon, and said edge having at least one aperture;
b. At least one binding means adapted to fit through said at least one aperture, whereby said binding means binds said plurality of plates.

13. The drawing kit for imparting the appearance of surface texture to paper according to claim 12, further comprising two binding rings and wherein said edge of each of said plates has two apertures for receiving said two binding rings.

14. The drawing kit for imparting the appearance of surface texture to paper according to claim 12, further comprising a plurality of binding rings and wherein said edge of each of said plates has an equal number of apertures for receiving said plurality of binding rings.

15. The drawing kit for imparting the appearance of surface texture to paper according to claim 12, wherein said second surface has a rough texture disposed thereon.

16. The drawing kit for imparting the appearance of surface texture to paper according to claim 12, wherein said textures can be animal skin textures, plant material textures and geometric forms textures.

17. The drawing kit for imparting the appearance of surface texture to paper according to claim 16, further comprising a first and a second cover, said first cover having outside surface with respect to the contents of the kit, said outside surface adapted to receive and hold one of said plurality of plates, said outside surface further adapted to firmly hold a piece of paper disposed upon said outside surface.

18. A drawing kit for imparting the appearance of surface texture to a piece of paper comprising:
a. A plurality of plates, each of said plurality of plates having a first surface and second surface, said first surface having a rough texture disposed thereon, said texture capable of being an animal skin texture, a plant material texture and a geometric form texture;
b. A receptacle adapted to receive said plurality of plates, said receptacle comprising at least one rigid side with a first plurality of securing means for temporarily holding one of said plurality of plates securely upon an outer surface of said rigid side and with a second plurality of securing means temporarily holding a piece of paper securely over one of said plurality of plates held upon said outer surface.

19. The drawing kit for imparting the appearance of surface texture to paper according to claim 18, wherein said second surface has a rough texture disposed thereon.
